(19) United States
(12) Patent Application Publication
(10) Pub. No.: US 2016/0106065 A1
(43) Pub. Date: Apr. 21, 2016

(54) Animal grooming station

(71) Applicant: Linda Minze, San Antonio, TX (US)

(72) Inventor: Linda Minze, San Antonio, TX (US)

(21) Appl. No.: 14/918,179

(22) Filed: Oct. 20, 2015

Related U.S. Application Data
(60) Provisional application No. 62/065,759, filed on Oct. 20, 2014.

(51) Int. Cl. A01K 13/00

(52) U.S. Cl. CPC A01K 13/00

(57) ABSTRACT

An animal grooming station provides compact and convenient storage for hanging and storing animal cleaning devices. The station is comprised of four legs, an upper cross member, a lower cross member, and hooks configured in a sawhorse-like structure. The upper cross member is supported by the legs and provides hooks attached to the bottom side of the upper cross member. The hooks are used for hanging the animal cleaning devices, such as a poopy scooper, one or more grooming brushes, and a bucket.

### CROSS-REFERENCE TO RELATED APPLICATIONS

This Application claims the benefit of U.S. Provisional Application No. 62/065,759, filed Oct. 20, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to animal care equipment and supplies, and in particular to an animal grooming station. Whether caring for pets or domesticated livestock, keeping the animal clean is important. Mud and animal feces can become matted into the fur, creating a substantial health risk to both animals and humans. Various cleaning and grooming devices are available, but keeping them organized can be a challenge. Animals deserve proper care, and therefore any device which would save time during the course of performing these tasks would be well received. An animal grooming station, which keeps the animal cleaning and grooming devices neatly stored and organized, would satisfy this demand.

### SUMMARY OF THE INVENTION

Accordingly, the invention is directed to an animal grooming station. The station provides compact and convenient storage for hanging and storing animal cleaning devices. The station is comprised of four legs, an upper cross member, a lower cross member, and hooks configured in a sawhorse-like structure. The upper cross member is supported by the legs and provides hooks attached to the bottom side of the upper cross member. The hooks are used for hanging the animal cleaning devices, such as a poopy scooper, one or more grooming brushes, and a bucket.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a side perspective view of the first exemplary embodiment , displaying the upper cross member 10, the hooks 14, the legs 11, the lower cross member 12, and the pegs 13.

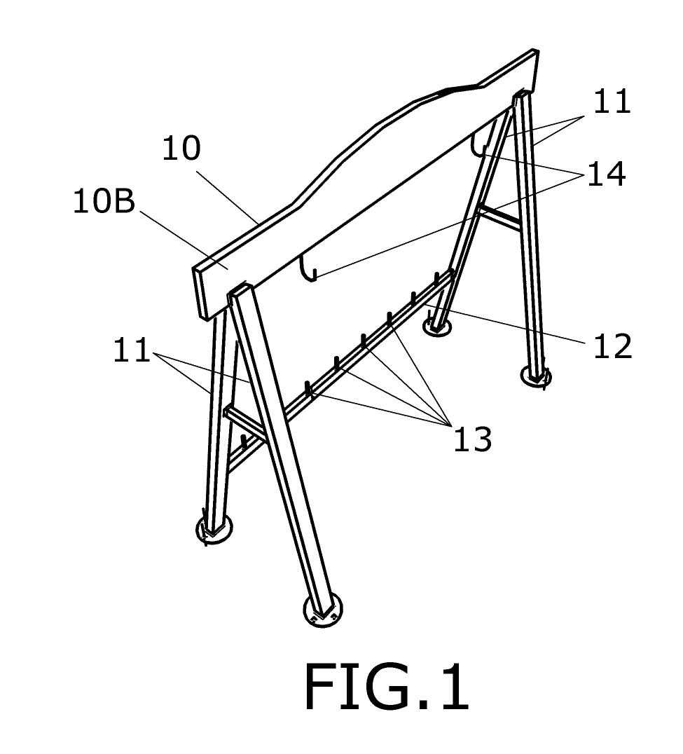

FIG. 2 is a front perspective view of the first exemplary embodiment, displaying the upper cross member 10, the hooks 14, the legs 11, the lower cross member 12, and the pegs 13.

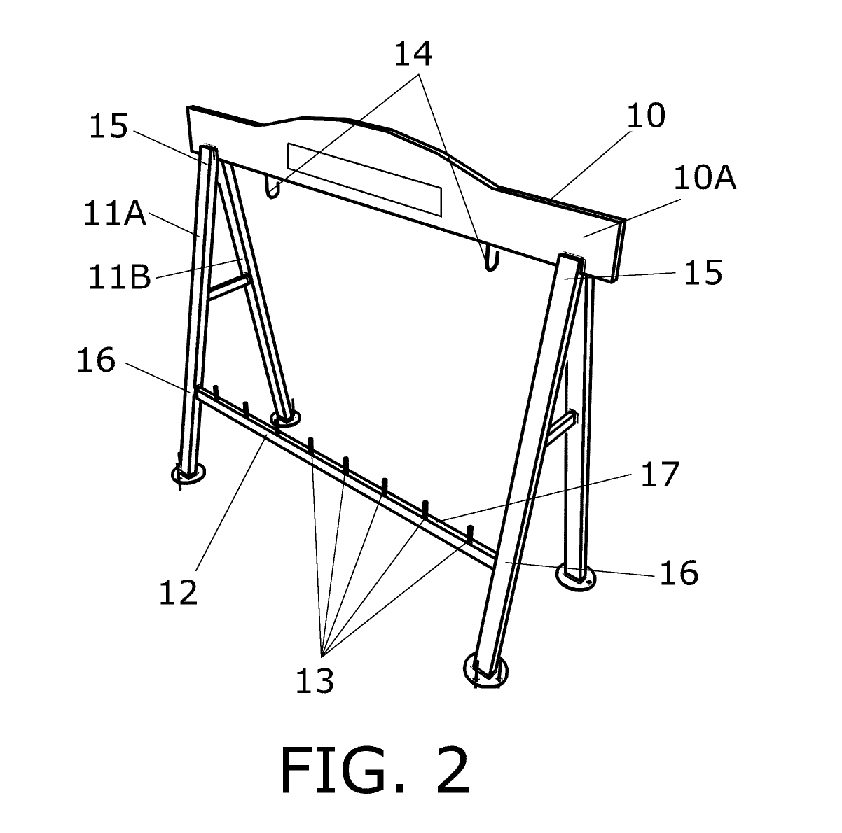

### DETAILED DESCRIPTION OF THE INVENTION

Referring now to the invention in more detail, the invention is directed to an animal grooming station.

The invention is intended for use with animal cleaning and grooming devices, but this is not intended as a limitation. With suitable modification, the invention may be used to organize and store any collection of items which may be stored by hanging them on hooks 14.

The first exemplary embodiment is comprised of an animal grooming station, which is comprised of four legs 11, an upper cross member 10, a lower cross member 12, and hooks 14 configured in a sawhorse-like structure. A first pair of legs 11 meet at their upper ends 15 and connect to a first end of the upper cross member 10. A front leg 11A attaches to a front side 10A of the upper cross member 10 and a back leg 11B attaches to a back side 10B of the upper cross member 10. A second set of the legs 11 meet at their upper ends 15 and connect to a second end of the upper cross member 10. A front leg 11A attaches to a front side 10A of the upper cross member 10 and a back leg 11B attaches to a back side 10B of the upper cross member 10. The front leg 11A and back leg 11B of any pair preferably meet at the same point along the length of the upper cross member 10.

The station provides compact and convenient storage for hanging and storing animal cleaning devices. The upper cross member 10 is supported by the legs 11 and provides hooks 14 attached to the bottom side of the upper cross member 10. The hooks 14 are used for hanging the animal cleaning devices, such as a poopy scooper, one or more grooming brushes, and a bucket. The lower cross member 12 joins two of the legs 11 at the front of the device near their lower ends 16. A row of pegs 13 is also provided on the top surface 17 of the lower cross member 12 for additional storage.

To use the first exemplary embodiment, the user places the station in the desired location to clean one or more animals. The user may then hang one or more cleaning devices on the hooks 14 and the pegs 13.

The upper cross member 10, the legs 11, and the lower cross member 12 are preferably manufactured from a rigid, durable material, such as wood. The hooks 14 and the pegs 13 are preferably manufactured from a rigid, durable material which is corrosion resistant, such as aluminum alloy or steel. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

(1) An animal grooming station, comprising:
(a) a plurality of legs having upper ends;
(b) said plurality of legs including front legs and back legs;
(c) an upper cross member having a front side and a back side;
(d) said upper ends meeting at and connecting to said upper cross member;
(e) said plurality of front legs connect to said front side and said plurality of back legs connect to said back side;
(f) a lower cross member;
(g) said lower cross member connecting towards a lower end of said plurality of front legs;
(h) a plurality of hooks;
(i) said plurality of hooks being attached to said upper cross member;

2. animal grooming station of claim 1, wherein said plurality of front legs and said plurality of back legs are equal in number.

3. animal grooming station of claim 2, wherein said plurality of front legs is equal to two in number and said plurality of back legs is equal to two in number.

4. animal grooming station of claim 2, wherein said plurality of front legs are connected opposite said plurality of back legs on said upper cross member such that said plurality of legs form pairs.

5. animal grooming station of claim 3, wherein said plurality of front legs are connected opposite said plurality of back legs on said upper cross member such that said plurality of legs form pairs.

6. animal grooming station of claim 1, further comprising a plurality of pegs; said plurality of pegs being aligned in a row and attached to a top surface of said lower cross member.

7. animal grooming station of claim 2, further comprising a plurality of pegs; said plurality of pegs being aligned in a row and attached to a top surface of said lower cross member.

8. animal grooming station of claim 3, further comprising a plurality of pegs; said plurality of pegs being aligned in a row and attached to a top surface of said lower cross member.

9. animal grooming station of claim 4, further comprising a plurality of pegs; said plurality of pegs being aligned in a row and attached to a top surface of said lower cross member.

10. e animal grooming station of claim 5, further comprising a plurality of pegs; said plurality of pegs being aligned in a row and attached to a top surface of said lower cross member.

11. e animal grooming station of claim 1, wherein said hooks are configured such that one or more cleaning devices may be hung from said hooks.

12. e animal grooming station of claim 2, wherein said hooks are configured such that one or more cleaning devices may be hung from said hooks.

13. e animal grooming station of claim 3, wherein said hooks are configured such that one or more cleaning devices may be hung from said hooks.

14. e animal grooming station of claim 4, wherein said hooks are configured such that one or more cleaning devices may be hung from said hooks.

15. e animal grooming station of claim 5, wherein said hooks are configured such that one or more cleaning devices may be hung from said hooks.

16. e animal grooming station of claim 6, wherein said pegs are configured such that one or more cleaning devices may be stored using said pegs.

17. e animal grooming station of claim 7, wherein said pegs are configured such that one or more cleaning devices may be stored using said pegs.

18. e animal grooming station of claim 8, wherein said pegs are configured such that one or more cleaning devices may be stored using said pegs.

19. e animal grooming station of claim 9, wherein said pegs are configured such that one or more cleaning devices may be stored using said pegs.

20. animal grooming station of claim 10, wherein said pegs are configured such that one or more cleaning devices may be stored using said pegs.
